(19) United States
(12) Patent Application Publication
(10) Pub. No.: US 2018/0247229 A1
(43) Pub. Date: Aug. 30, 2018

(54) ORIGIN-DESTINATION LEVEL WAITLIST CLEARANCE TRIGGERING

(71) Applicant: Amadeus S.A.S., Biot (FR)

(72) Inventors: Cécile M. Thanh-Tam Lam, Vallauris (FR); Antoine Cheinet, Grasse (FR); Patrice Ambolet, Roquefort les Pins (FR)

(21) Appl. No.: 15/443,321

(22) Filed: Feb. 27, 2017

(51) Int. Cl. G06Q 10/02; G06Q 10/08

(52) U.S. Cl. CPC G06Q 10/02; G06F 17/3053; G06Q 10/087

(57) ABSTRACT

Systems, methods, and computer program products for processing waitlisted reservations. In response to detecting an event that impacts an availability of inventory in a market, a waitlist clearance processes may identify waitlisted reservation records that include a travel solution connecting an origin-destination pair in the market. Reservation records having travel solutions that are competing for available inventory may be grouped together, and the reservation records ranked within the group. Confirmation of waitlisted travel solutions in the highest ranked reservation record may be requested, and if availability is sufficient to accommodate the waitlisted travel solution, the waitlisted travel solution confirmed. The clearance process may continue to select the next highest ranked reservation record in the group, and request confirmation in the ranked order until the availability is no longer sufficient to accommodate another waitlisted travel solution, or each reservation record in the group has been processed.

### BACKGROUND

The invention generally relates to computers and computer systems and, in particular, to methods, systems, and computer program products that trigger processing of waitlisted database records.

At times, a user attempting to book a resource will find that a the resource is unavailable. For example, the user may be unable to confirm a space in a transportation network because spaces in a desired class or that connect a desired origin point to a desired destination point are unavailable. When a preferred resource is unavailable, the user may request that a space in the resource be booked in a waitlisted database record associated with the user. If the preferred resource later becomes available, the provider of the resource may confirm booking of the resource for the user based on the waitlisted database record, and inform the user of the confirmation.

Waitlisted database records may enable providers to confirm waitlisted bookings in response to spaces becoming available for the booked resource. However, due complexities in how availability is determined, it is often difficult to determine when sufficient spaces have become available to confirm a particular waitlisted database record, or which waitlisted database records should be confirmed with the newly available spaces first. This may result in waitlisted database records not being confirmed as soon as new spaces become available. As a result, the spaces may go unused, or new bookings may be confirmed for the available spaces ahead of the waitlisted database records.

Thus, improved systems, methods, and computer program products for processing waitlisted database records are needed that identify when spaces become available, and that determine how to use the available spaces to confirm waitlisted database records.

### SUMMARY

In an embodiment of the invention, a system is provided that includes one or more processors and a memory coupled to the processors. The memory stores a first database of control parameters each associated with one or more origin-destination pairs, a second database of reservation records each defining a travel solution, a third database of index records each associating a respective reservation record in the second database with an origin-destination pair that corresponds to the travel solution defined by the respective reservation record, and program code. When executed by at least one of the one or more processors, the program code causes the system to, in response to detecting an update to the first database, identify one of the control parameters in the first database that was modified by the update. The system further retrieves, from the third database, each index record for which the origin-destination pair matches one of the one or more origin-destination pairs associated with the identified control parameter, and retrieves, from the second database, each reservation record corresponding to at least one of the index records retrieved from the third database. The system further selects a reservation record from the reservation records retrieved from the second database, determines an availability of spaces for the travel solution defined by the selected reservation record using the identified control parameter from the first database, and if the availability of spaces is sufficient to accommodate the travel solution, confirms the travel solution.

In another aspect of the invention, each respective reservation record associated with a corresponding origin-destination pair by the third database of index records has a status of waitlisted, and the program code further causes the system to, in response to confirming the travel solution, update the status of the respective reservation record from waitlisted to confirmed.

In another aspect of the invention, the program code causes the system to determine the availability of spaces for the travel solution by transmitting a query identifying the respective reservation record and a number of passengers to be accommodated to an inventory system, determining, by the inventory system, whether there are available spaces for the number of passengers, and in response to there being the available spaces, transmitting a reply from the inventory system indicating the availability of spaces is sufficient.

In another aspect of the invention, the reservation records retrieved from the second database comprise a first set of reservation records, and the program code causes the system to select the reservation record by, for each reservation record in the first set of reservation records, determining the availability of spaces for the travel solution defined by the reservation record using the identified control parameter from the first database, and if the availability of spaces is sufficient to accommodate the travel solution, adding the reservation record to a second set of reservation records. The system then ranks each reservation record in the second set of reservation records, and identifies a highest ranked reservation record in the second set of reservation records as the selected reservation record.

In another aspect of the invention, the program code causes the system to rank each reservation record in the second set of reservation records by determining a value for each reservation record in the second set of reservation records based on a characteristic of a passenger associated with the travel solution or an effective yield of the travel solution, and arranging each reservation record in the second set of reservation records based on the value.

In another aspect of the invention, the program code further causes, until the availability of spaces is no longer sufficient to accommodate another reservation record having the status of waitlisted, or each reservation record in the second set of reservation records has been processed, the system to iteratively determine the availability of spaces for the travel solution of a next highest ranked reservation record in the second set of reservation records, and if the availability of spaces is sufficient to accommodate the travel solution, confirm the travel solution.

In another aspect of the invention, the identified control parameter is one of a plurality of control parameters in the first database that were modified by the update, and the system retrieves each index record for which the origin-destination pair matches any one of the origin-destination pairs associated with any one of the plurality of control parameters that were modified.

In another aspect of the invention, the program code causes the system to detect the update to the first database by determining a first state of the first database of control parameters before the update, determining a second state of the first database of control parameters after the update, comparing the first state and the second state, and in response to the second state differing from the first state, indicating an occurrence of the update.

In another aspect of the invention, the update to the first database comprises a change of an active valuation strategy, a business rule, a yield, or a bid price.

In another embodiment of the invention, a method is provided. The method includes, in response to detecting the update to the first database, identifying the control parameter in the first database that was modified by the update. The method further includes retrieving each index record for which the origin-destination pair matches the one of the one or more origin-destination pairs associated with the identified control parameter from the third database, and retrieving, from the second database, each reservation record corresponding to the at least one of the index records retrieved from the third database. The method further includes selecting the reservation record from the reservation records retrieved from the second database, determining the availability of spaces for the travel solution defined by the selected reservation record using the identified control parameter from the first database, and if the availability of spaces is sufficient to accommodate the travel solution, confirming the travel solution.

In another aspect of the invention, each respective reservation record associated with the corresponding origin-destination pair by the third database of index records has the status of waitlisted, and the method further includes, in response to confirming the travel solution, updating the status of the respective reservation record from waitlisted to confirmed.

In another aspect of the invention, the method further includes determining the availability of spaces for the travel solution by transmitting the query identifying the respective reservation record and the number of passengers to be accommodated to the inventory system, determining, by the inventory system, whether there are available spaces for the number of passengers, and in response to there being the available spaces, transmitting the reply from the inventory system indicating the availability of spaces is sufficient.

In another aspect of the invention, the reservation records retrieved from the second database comprise the first set of reservation records, and selecting the reservation record comprises, for each reservation record in the first set of reservation records, determining the availability of spaces for the travel solution defined by the reservation record using the identified control parameter from the first database, and if the availability of spaces is sufficient to accommodate the travel solution, adding the reservation record to the second set of reservation records. The method further includes ranking each reservation record in the second set of reservation records, and identifying the highest ranked reservation record in the second set of reservation records as the selected reservation record.

In another aspect of the invention, the method further includes filtering the second set of reservation records to remove each reservation record for which the waitlist clearance is inhibited.

In another aspect of the invention, ranking each reservation record in the second set of reservation records includes determining the value for each reservation record in the second set of reservation records based on the characteristic of the passenger associated with the travel solution or the effective yield of the travel solution, and arranging each reservation record in the second set of reservation records based on the value.

In another aspect of the invention, until the availability of spaces is no longer sufficient to accommodate another reservation record having the status of waitlisted, or each reservation record in the second set of reservation records has been processed, the method iteratively determines the availability of spaces for the travel solution of the next highest ranked reservation record in the second set of reservation records, and if the availability of spaces is sufficient to accommodate the travel solution, confirms the travel solution.

In another aspect of the invention, the identified control parameter is one of the plurality of control parameters in the first database that were modified by the update, and the method further includes retrieving each index record for which the origin-destination pair matches any one of the origin-destination pairs associated with any one of the plurality of control parameters that were modified.

In another aspect of the invention, detecting the update to the first database includes determining the first state of the first database of control parameters before the update, determining the second state of the first database of control parameters after the update, comparing the first state and the second state, and in response to the second state differing from the first state, indicating the occurrence of the update.

In another embodiment of the invention, a computer program product is provided that includes a non-transitory computer-readable storage medium including program code. The program code is configured, when executed by the one or more processors of the system, to cause the system to, in response to detecting the update to the first database, identify one of the control parameters in the first database that was modified by the update, and retrieve, from the third database of index records, each index record for which the origin-destination pair matches the one of the one or more origin-destination pairs associated with the identified control parameter. The program code further causes the system to retrieve, from the second database, each reservation record corresponding to at least one of the index records retrieved from the third database, and select the reservation record from the reservation records retrieved from the second database. The program code further causes the system to determine the availability of spaces for the travel solution defined by the selected reservation record using the identified control parameter from the first database, and if the availability of spaces is sufficient to accommodate the travel solution, confirming the travel solution.

The above summary may present a simplified overview of some embodiments of the invention in order to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a reservation system, a revenue management system, an inventory system, a reservation database, a booking database, a control parameter database, and a network.

FIG. 2 is a diagrammatic view of an exemplary computer that may be used to provide the operating environment of FIG. 1.

FIG. 3 is a diagrammatic view of messages that may be transmitted between the reservation system, revenue management system, and inventory system of FIG. 1.

### DETAILED DESCRIPTION

Embodiments of the invention are directed to systems, methods, and computer program products for managing waitlisted reservation records, and may be implemented on a processing and database system, such as a Global Distribution System (GDS). The processing and database system may comprise one or more networked computers or servers that provide reservation, revenue, and inventory management for a transportation network.

Embodiments of the invention may implement a waitlist clearance process that is triggered by detecting changes to inventory control parameters at an origin-destination level. Once triggered, the waitlist process may confirm travel solutions in waitlisted reservation records if availability is sufficient to accommodate the travel solutions. Availability calculations for a particular reservation record may also take into account a context of the reservation record using active valuation strategies. Active valuation strategies may adjust the yield, or some other suitable inventory control parameter used to calculate availability in the travel network, based on context parameters of the context of the reservation record.

Once triggered, the waitlist clearance process may identify a set of reservation records that are eligible for waitlist clearing using a booking database that associates reservation records in a reservation database with respective origin-destination pairs. The waitlist clearance process may then determine the availability of inventory for waitlisted travel solutions in the reservation records, and priority levels for the reservation records in the set of reservation records. The waitlist clearance process may then attempt to confirm waitlisted travel solutions in the reservation records in an order established by the priority of the reservation records.

Embodiments of the invention may avoid problems caused by triggering waitlist clearance at a segment level, such as a failure to confirm waitlisted travel solutions in response to additional inventory being made available at the origin-destination level. Triggering waitlist clearance based on detected changes in inventory control parameters may allow a waitlisted booking to be confirmed more quickly and consistently than with systems that rely on segment level triggers. This improved triggering may prevent flights from departing with empty seats that could have been used to confirm the waitlisted booking, or available inventory from being confirmed for new bookings before waitlisted bookings can be confirmed. Identifying sets of waitlisted reservation records that could potentially be confirmed due to changes in inventory control parameters may also improve enforcement of priority ranking over using segment level triggers, since segment level triggers only identify reservation records waitlisted on the same segment.

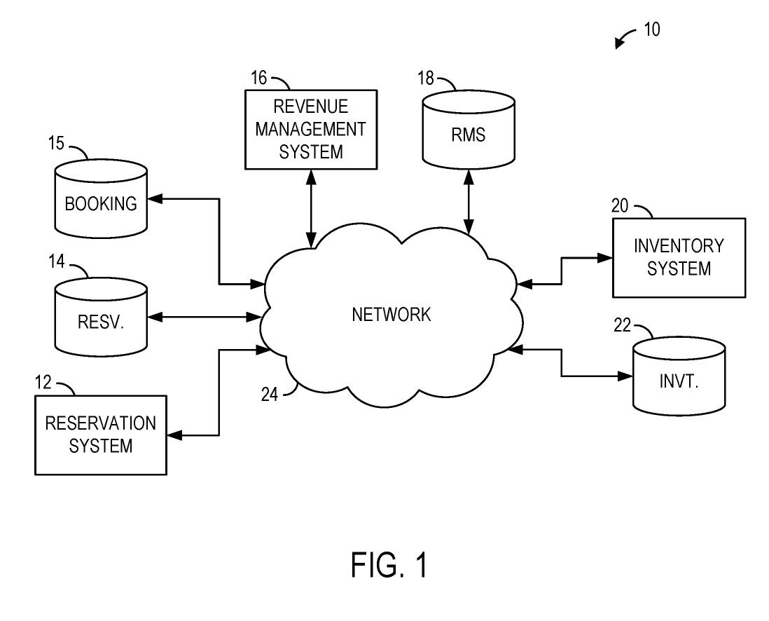

Referring now to FIG. 1, an operating environment 10 in accordance with an embodiment of the invention may include a reservation system 12, a revenue management system 14, an inventory system 16, a reservation database 18, a booking database 20, and a control parameter database 22. Each of the reservation system 12, revenue management system 14, inventory system 16, reservation database 18, booking database 20, and control parameter database 22 may communicate through a network 24. The network 24 may include one or more private or public networks (e.g., the Internet) that enable the exchange of data between systems connected to the network 24.

The reservation system 12 may be configured to store information, retrieve information, and conduct transactions related to the purchase of travel products, such as seats on one or more flights connecting an origin-destination pair. The reservation system 12 may manage reservations for a single travel service provider, or for multiple providers. In cases where the reservation system 12 manages reservations for multiple providers, the reservation system may operate as a Global Distribution System (GDS) that enables users to reserve products from each of the providers to which the reservation system 12 is connected.

In response to receiving a request to reserve a travel product, the reservation system 12 may generate a reservation record. The reservation record may be stored in the reservation database 18, and may comprise one or more data fields, or elements, that contain itinerary and traveler information. In an embodiment of the invention, the reservation record may be a Passenger Name Record (PNR).

The revenue management system 14 may be configured to determine an expected revenue impact of making spaces available for purchase in each of several booking classes. A booking class may provide marketing segmentation by dividing seats within a cabin into groups. Each booking class may be subject to different conditions, and may be identified in the reservation record by a code. Booking classes within a coach cabin, for example, may include eco-1 (exchangeable and refundable), eco-2 (exchangeable but not refundable), and eco-3 (neither exchangeable nor refundable). Pricing may be segmented within each cabin by establishment of multiple booking classes within the cabin, and may involve different tariffs within those classes for each specific market. Booking classes may thereby be used as a revenue management tool.

Each carrier may have a limited capacity, and each unit of that capacity may have a perish time by which the unit must be sold to avoid being lost. For example, a carrier may have a maximum number of seats available in each of one or more cabins for a specific market or flight. Once an aircraft has left the gate, the profit from an unsold seat is lost, and the product is said to have perished or spoiled. The actual perish time may occur prior to departure to account for the time required for processing the ticket, check in, security screening, boarding, and so forth.

A space may be distinguished from a seat based on the concept of overbooking. Overbooking refers to the practice by which providers book more spaces than there are physical seats on a flight in anticipation that some booked spaces will go unused due to passengers failing to show up at the time of departure. The cost of not selling a space may be a current expected value of selling the space at some time in the future, or the “opportunity cost” of the space. The opportunity cost, or “bid-price” may vary depending on the amount of unsold inventory and the amount of time remaining until the perish time. The bid-price may represent a probabilistic expected revenue for the next space offered to sell for a given remaining inventory of spaces and amount of time until the space perishes. To maximize revenue for this limited inventory, the revenue management system 14 may determine the bid price for spaces, and open and close certain booking classes based on the bid-price.

The above inventory gating strategy may be based on bid-prices computed periodically (e.g., once a day), which may in turn be used to determine availability for each booking class. Plotting the bid-price verses remaining spaces n at time t may produce a bid-price vector BP(n, t). The bid-price vector BP(n, t) may provide a minimum price that the carrier should accept for booking the next available space for a given remaining inventory n and time t. A bid-price vector BP(n, t) may be determined for each origin-destination pair in the transportation network and stored in the control parameter database 22.

The revenue management system 14 may be configured to determine a yield for each booking class and each origin-destination pair in the transportation network. The yield may reflect an expected revenue per space sold, and may vary by booking class, market, and perish date for each space. In addition to the expected fare, yield may take into account costs of providing the space, such as charges for airport taxes and fuel. Yield may be determined, for example, using historical data, forecasted demand, and statistical algorithms. The yield may be determined for each booking class in each cabin for each origin-destination pair in the transportation network, and stored in the control parameter database 22.

The inventory system 16 may determine how many spaces from the remaining inventory should be made available in each booking class based on the bid-price and yield provided by the revenue management system 14. If the bid-price is lower than the yield, the inventory system 16 may make spaces available for that booking class, in which case the booking class is said to be “open”. In contrast, if the bid-price is above the yield, the inventory system 16 may close the booking class since the opportunity cost of the next unit of inventory exceeds the price for which the ticket is expected to sell. The availability of spaces for satisfying a specific request for spaces on a particular segment or travel solution at a particular time may also depend on yield modifier rules applicable to that request. Thus, changes in yield may directly affect the number of spaces that are available in each booking class for each cabin and segment of the transportation network that are determined from the yield being changed.

The inventory system 16 may separate the process of revenue optimization into pricing and inventory control functions. Product inventory control may be implemented by periodic adjustment of nested booking limits for the various booking classes so as to optimize the passenger mix between booking classes, thereby maximizing generated revenue. In particular, the objective of the inventory system 16 may be to fly each aircraft as full as possible without allowing discount-fare passengers to displace full-fare passengers. The inventory system 16 may define how many spaces are available on a particular flight or in a particular market at any given time by opening and closing individual booking classes in accordance with rules defined by the carrier or by the revenue management system 14. Because the inventory system 16 determines availability at the origin-destination level in dependence on a large number of variables that can vary between requests (e.g., yield, bid price, point of sale, connection points, flight path, customer characteristics, etc.), availability is typically calculated by the inventory system 16 for each request for availability at the time the request is received.

The reservation database 18 may comprise a stand-alone database system, a database system integrated with the reservation system 12, or a database maintained by another system. Each reservation record in the reservation database 18 may include data defining an itinerary for a particular trip, passenger, or group of passengers. The defined itinerary may include travel services from multiple travel service providers. To facilitate locating the reservation record in the reservation database 18, a record locator or other suitable identifier may be associated with, and uniquely identify, each reservation record in the reservation database 18.

Each reservation record may include elements that identify segments on which space has been reserved for a specific flight. The reservation record may thereby define a travel solution that provides one or more spaces for travel between an origin-destination pair at a specific time. A segment may refer to the operation of an aircraft between a point where passengers first board the aircraft and a point where the passengers exit the aircraft for a final time. A segment may include one or more legs provided by a single aircraft with the same flight designator, with each leg comprising operation of the aircraft from one scheduled departure station to the next scheduled arrival station. Thus, a segment may include any number of stops where passengers can exit and re-board the same aircraft.

A flight may refer to the operation of one or more segments with the same flight designator, and may involve more than one aircraft. To book a flight that includes multiple segments, multiple elements each defining a segment of the flight may be created in the reservation record. Travel solutions including more than one flight may be referred to as having a “connecting flight”. Connecting flights may require the passenger to disembark from the aircraft providing one segment, and board another aircraft providing another segment at a station between the origin and destination.

The booking database 20 may store index records. Each index record may associate a reservation record in the reservation database 18 with one or more origin-destination pairs, travel solutions, booked classes, booked cabins, and/or booking statuses. Index records may also associate their respective reservation records with additional data, such as a status of the reservation record or an element defined by the reservation record. The reservation records indexed by the booking database may be reservation records having a particular status, such as “waitlisted”. The booking database 20 may thereby facilitate identification of reservation records having waitlisted travel solutions with the potential to be confirmed due to changes in one or more inventory control parameters.

For example, in response to receiving a market query including an inventory control parameter, the booking database 20 may return a set of origin-destination pairs that is associated with the inventory control parameter and which defines the market. A waitlist clearance process may use the reservation database 18 and booking database 20 to return a set of reservation records eligible for waitlist clearance processing. An eligible reservation record may be a reservation record that includes, for example, a travel solution that connects an origin-destination pair in the market if the travel solution also includes a segment controlled by the carrier performing the waitlist clearance, e.g., that connects a “base” origin-destination pair. In an embodiment of the invention, the booking database 20 may comprise a table or other object in another database, such as in reservation database 18 or control parameter database 22.

The control parameter database 22 may be used to store and maintain the inventory control parameters. Inventory control parameters may include the yield and bid prices generated by the revenue management system, as well and active valuation rules. Active valuation rules may be used to adjust yield for a travel solution based on a context of the booking request, e.g., the point-of-sale, travel itinerary, and traveler characteristics. Active valuation rules may enable precise control of the availability calculation at a per-request level by adjusting the yield used to calculate availability based on a business rule as applied to the context of the request. For example, an active valuation rule may increase the yield for requests received from a particular point-of-sale, for requests for spaces between a specific origin-destination pair, or for flights in a particular market. The control parameter database 22 may also be used to store the historical data used to determine yield, and/or any other business rules that can impact availability in the transportation network. The control parameter database 22 may thereby provide a database of inventory control parameters that impact availability of inventory in the transportation network.

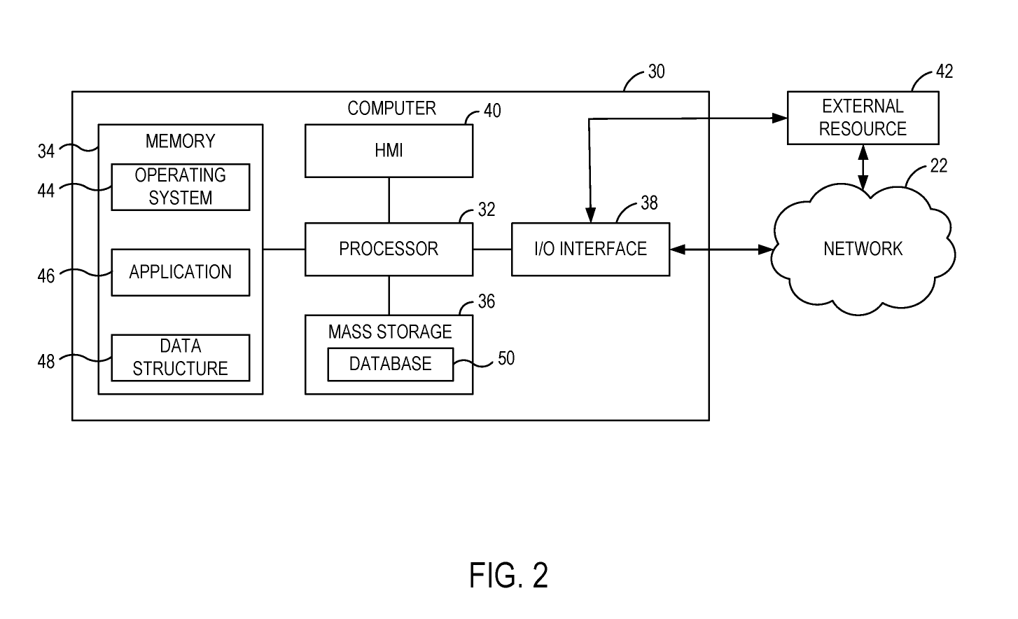

Referring now to FIG. 2, the reservation system 12, revenue management system 14, inventory system 16, reservation database 18, booking database 20, control parameter database 22, and network 24 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 24 or I/O interface 38. External resources may include, but are not limited to, servers, databases, mass storage devices, peripheral devices, cloud-based network services and/or memory, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing data. The mass storage memory device 36 may include data storage devices such as a hard drive, optical drive, tape drive, volatile or non-volatile solid state device, or any other device capable of storing data.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include a running instance of an application comprising a server, which may accept requests from, and provide responses to, one or more corresponding client applications. One or more data structures 48 may also reside in memory 34, and may be used by the processor 32, operating system 44, and/or application 46 to store and/or manipulate data.

The I/O interface 38 may provide a machine interface that operatively couples the processor 32 to other devices and systems, such as the network 24 or external resource 42. The application 46 may thereby work cooperatively with the network 24 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, it should be understood that embodiments of the invention may include applications that are located externally to the computer 30, distributed among multiple computers or other external resources 42, or provided by computing resources (hardware and software) that are provided as a service over the network 24, such as a cloud computing service.

The HMI 40 may be operatively coupled to the processor 32 of computer 30 to enable a user to interact directly with the computer 30. The HMI 40 may include video or alphanumeric displays, a touch screen, a speaker, and/or any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof.

A database management system in the form of a computer software application executing as instructions on the processor 32 may be used to access data stored in records of the database 50 in response to a query, where the query may be dynamically determined and executed by the operating system 44, other applications 46, or one or more modules. Although embodiments of the invention may be described herein using relational, hierarchical, network, object-oriented, or other database terminology in specific instances, it should be understood that embodiments of the invention may use any suitable database management model, and are not limited to any particular type of database.

One or more of the reservation system 12, revenue management system 14, and inventory system 16, operating individually or in cooperation with other systems, may provide a waitlist clearance process. The waitlist clearance process may evaluate waitlisted bookings in response to detecting an update to an inventory control parameter. In particular, updates that could produce sufficient availability of spaces for a requested origin-destination pair may trigger the waitlist clearance process. External events may also trigger the waitlist clearance process. External events may include receiving an indication from a third party system that an event with the potential to affect availability in an identified market has been occurred. If the waitlist clearance process determines available inventory is sufficient to confirm a waitlisted travel solution, reservation records including the waitlisted travel solution may be confirmed in an order based on a determined priority of each reservation record. This priority may be based, for example, on a customer value of one or more passengers listed in the reservation record.

To detect changes in inventory control parameters, the revenue management system 14 may compare data in the control parameter database 22 before and after an update. Exemplary inventory control parameters may include yields for booking classes offered between the origin and destination, bid-prices for units of inventory connecting the origin and destination, business rules that potentially impact the availability of inventory (e.g., a revenue control bypass rule that activates or deactivates the use of revenue controls on a given origin-destination under pre-defined conditions), and active valuation strategies. Detecting a change to an inventory control parameter may indicate an occurrence of an event that impacts availability in the transportation network.

Active valuation strategies may adjust origin-destination yields depending on the context of the reservation record. The context of the reservation record may include context parameters such as a Point-of-Sale (POS), a characteristic of the trip (e.g., the operating carrier is different than the validating carrier), or a characteristic of the passenger (e.g., the passenger is in a frequent flyer program). Context may also include context parameters relating to a competing carrier, such as availability and prices of spaces provided by the competing carrier in the market defined by the origin and destination.

Active valuation strategies may allow available inventory to be quickly adapted to a specific market without waiting until the next yield or bid-price adjustment cycle. To this end, active valuation strategies may include the application of competition adjustment rules that adjust yield in response to competition in the market. By way of example, competition adjustment rules may adjust yield in a market (e.g., NCE-JFK) based on prices and availability of spaces provided by other carriers on competing flights (e.g., NCE-JFK, NCE-CDG-JFK, NCE-LHR-JFK, and NCE-FRA-JFK) that serve the market.

Conventional systems may periodically compute availability at a segment level using yield and bid price, or maximum available capacities (i.e., “authorization levels”), within each of one or more booking classes. In these systems, waitlist clearance is typically triggered in response to changes in available inventory at the segment level. One improvement that may be provide by triggering waitlist clearance processes based on inventory control parameters rather than available segment inventory may be the timeliness and consistency with which waitlisted reservations are confirmed.

As an example of how conventional triggering (e.g., triggering at the segment level) can result in a failure to confirm a waitlisted travel solution, reservation record XXXXXX may include a travel solution that connects origin AAA to destination CCC. This travel solution may include segments AAA-BBB and BBB-CCC, with each segment being waitlisted in booking class R. A segment level trigger may trigger waitlist clearance for reservation record XXXXXX in response to the pre-computed availability in the inventory database 22 increasing for segment AAA-BBB or segment BBB-CCC. Pre-computed availabilities may be recomputed periodically based on inventory control parameters, a remaining number of spaces within the authorization level for the class, or a combination of the two.

In the above example, if the yield for class R is increased for origin-destination AAA-CCC, the pre-computed availability of segments AAA-BBB and BBB-CCC may remain unaffected until the availability is recomputed. Thus, the increase in yield itself may fail to trip segment-level triggers for the travel solution. Newly available spaces may therefore remain empty if no new bookings are received, or may be sold to a new passenger that requests a booking on a travel solution that includes either segment AAA-BBB or segment BBB-CCC.

Triggers based on inventory control parameters may also improve operation of ranking systems that determine the order in which waitlisted reservation records should be confirmed as compared to systems that use segment level triggers. All waitlisted reservation records that are eligible for confirmation due to changed inventory control parameters may not always share the same segment. Thus, each segment level trigger may typically identify only a portion of the total number of eligible reservation records. The net effect may be that reservation records are ranked in batches against other reservation records that share the segment responsible for the trigger. However, because all waitlisted travel solutions in the reservation records identified by the segment based trigger may be confirmed, lower ranked reservation records that include earlier triggered segments may consume available inventory that could have been used to confirm higher ranked, but later triggered, reservation records.

As an example of this type of failure, reservation record XXXXXX described above may have a lower priority than reservation record YYYYYY. Reservation record YYYYYY may include a travel solution that connects origin BBB to destination DDD using segments BBB-CCC and CCC-DDD, with each segment being waitlisted in booking class R. Thus, reservation records XXXXXX and YYYYYY may compete over available inventory in segment BBB-CCC, but not over connecting segment AAA-BBB in reservation record XXXXXX or connecting segment BBB-DDD in reservation record YYYYYY. Thus, if there is only one space available for booking class R on segment BBB-CCC, only one of the reservation records can be confirmed, assuming sufficient availability on the other segments.

If the airline decides to implement an active valuation strategy that increases the adjusted yields for booking class R in a market that includes AAA-CCC and BBB-DDD, reservation records XXXXXX and YYYYYY may both be eligible for waitlist clearance processing. However, if an increase in the availability of spaces in booking class R on segment AAA-BBB triggers waitlist clearance prior to a corresponding increase in segments BBB-CCC or CCC-DDD, reservation record XXXXXX may be selected for waitlist clearance processing prior to reservation record YYYYYY. Under this scenario, travel solution AAA-BBB-CCC of reservation XXXXXX may be confirmed on segments AAA-BBB and BBB-CCC, thereby taking the last available space in class R on segment BBB-CCC. Thus, although inventory was available that could have been used to confirm the waitlisted travel solution in reservation record YYYYYY, and reservation YYYYYY had a higher priority than reservation XXXXXX, segment level triggering in this exemplary case led to the waitlisted travel solution in reservation XXXXXX being confirmed. Embodiments of the invention may address this problem by eliminating inconsistencies between how waitlist clearance processes are triggered, and how availabilities are adjusted using inventory control parameters.

Storing availability information at the origin-destination level may be costly in terms of required computing effort and amount of storage due to the number of parameters (e.g., point of sale, connection points, flight path, customer characteristics) that may contribute to availability at the origin-destination level. To avoid this problem, and improve performance of at least the reservation and inventory systems, embodiments of the invention may detect an increase in availability at the origin-destination level by monitoring control parameters that are used as input to the availability computation. The inventory control parameters monitored may include bid prices, yields, and yield modifiers used to implement active valuation strategies. Monitoring processes may detect updates to yield and active valuation strategy databases, and trigger waitlist clearance for waitlisted travel solutions connecting an origin-destination pair that is impacted by a detected update.

Triggering updates based on changes to inventory control parameters at the origin-destination level may result in a larger number of reservation records being identified for waitlist clearance processing for each trigger as compared to segment level triggers. To reduce processing loads, the reservation system 12 may be configured to trigger waitlist clearance processing for identified reservation records having more than one waitlisted travel solution once per detected event. The reservation system 12 may then attempt to confirm all waitlisted segments in each identified reservation record in the order that the reservation record is selected for processing. In addition, the reservation system 12 may filter out identified reservation records having inhibit waitlist clearance flags or that have connecting segments that do not have sufficient availability to confirm a waitlisted travel solution.

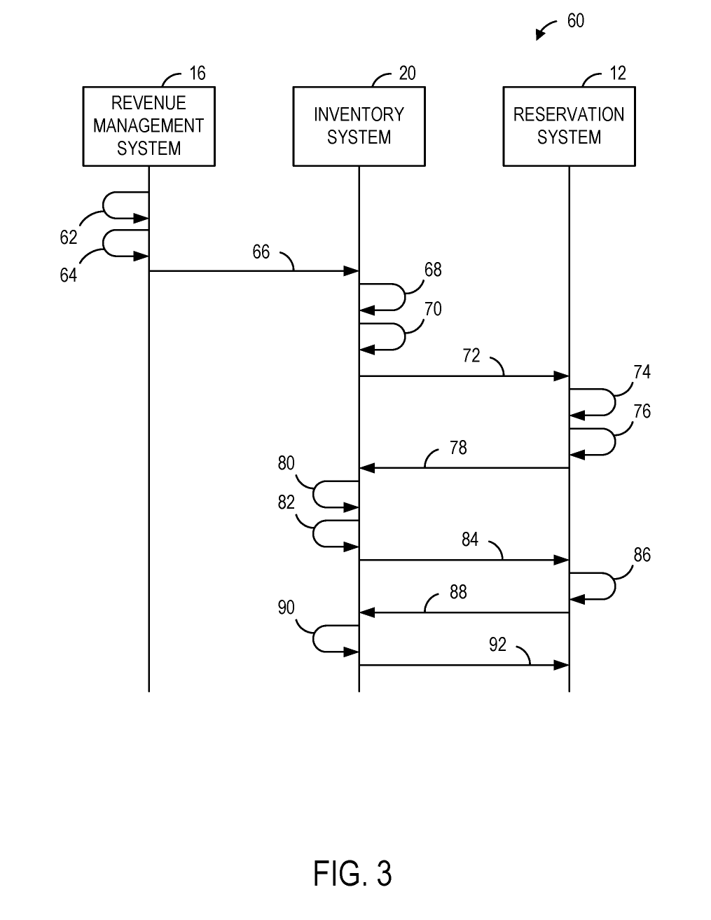

Referring now to FIG. 3, an exemplary waitlist clearance process 60 is depicted that may be executed in accordance with an embodiment of the invention. Changes to inventory control parameters, and their impact on the availability of inventory connecting corresponding origin-destination pairs, may be performed on the inventory side. To this end, in response to an update of the control parameter database 22, the revenue management system 14 may perform a comparison 62 of the control parameter database 22 before and after the update. Updates that may be detected by the comparison 62 may include changes to yield, bid price, active valuation strategies, or business rules governing inventory offered in a market. A market may be defined at any origin-destination level, e.g., airport-to-airport (i.e., between a single origin-destination pair), country-to-country, region-to-region, or world-to-world (i.e., all origin-destination pairs in the transportation network). Based on the comparison 62, the revenue management system 14 may generate a list of impacted origin-destination pairs or markets 64, and transmit the list of impacted markets 66 to the inventory system 16.

By way of an exemplary scenario, Carrier A may launch a promotion in a market, such as country-to-country market Germany-United States. In accordance with the promotion, Carrier A may set an active valuation strategy that increases yields in the market to 110% of their previous value. This increase in yield may cause an increase in the availability of inventory in the market, thereby triggering the waitlist clearance process 60 with the impacted market DE-US as an input parameter.

Table 1 provides exemplary list of reservation records that may be identified by the inventory system 16 and/or by one or more index records in the booking database 20 under the exemplary scenario involving Carrier A and the market promotion described above.

TABLE 1
LIST OF IDENTIFIED RESERVATION RECORDS

| Reservation | Booking | | | Booking | |
|---|---|---|---|---|---|
| Record | Status | O & D | Travel Solution | Class | Cabin |
| VVVVVV | HL | HAM-FRA-JFK | CA1(HL)-CA2(HL) | C-C | C-C |
| WWWWWW | HL | FRA-JFK-MIA | CA2(HL)-CA3(HL) | C-C | C-C |
| ZZZZZZ | HL | MUC-JFK-MIA | CA4(HL)-CA3(HL) | C-C | C-C |

Each of the reservation records in the list may be identified by a unique identifier, such as the depicted record locators VVVVVV, WWWWWW, ZZZZZZ, and may have a booking status that indicates the reservation record is waitlisted. Exemplary booking status values may include HL (waitlisted), UC (denied), and HK (confirmed). The list may also identify a travel solution comprising a combination of flight segments that connect the respective origin-destination pair, and booking and cabin classes (e.g., C or “coach”) for each reservation record.

The travel solution shown for reservation VVVVVV comprises a connecting flight including a segment CA1 provided by Carrier A that connects Hamburg to Frankfurt, and a segment CA2 provided by Carrier A that connects Frankfurt to John F. Kennedy. Because the origin (Hamburg) is in Germany, and the destination (John F. Kennedy) is in the United States, the reservation record VVVVVV may be identified as eligible for waitlist clearance processing due to changes that affect available inventory in the DE-US market.

The travel solution shown for reservation WWWWWW comprises a connecting flight including the segment CA2 that connects Frankfurt to John F. Kennedy, and a segment CA3 provided by Carrier A that connects John F. Kennedy to Miami. The origin for reservation record WWWWWW (Frankfurt) is in Germany, and the destination (Miami) is in the United States. Thus, reservation record WWWWWW may also be considered eligible for waitlist clearance processing due to changes that affect available inventory in the DE-US market.

The travel solution shown for reservation ZZZZZZ comprises a connecting flight including a segment CA4 provided by Carrier A that that connects Munich to John F. Kennedy, and the segment CA3 that connects John F. Kennedy to Miami. The origin for reservation record ZZZZZZ (Munich) is in Germany, and the destination (Miami) is in the United States. Thus, reservation record WWWWWW may also be considered eligible for waitlist clearance processing due to changes that affect available inventory in the DE-US market.

Under the exemplary scenario described above, each of the reservation records depicted in Table 1 may be considered eligible for waitlist clearance because each reservation record is associated with an origin-destination that is included in the market DE-US, and comprises at least one segment provided by Carrier A, i.e., the origin-destination is a base origin-destination. Accordingly, the availability of units of inventory for these reservation records may be impacted by the promotion initiated by Carrier A.

In response to receiving the list of impacted markets, the inventory system 16 may identify waitlisted reservation records 68 that are eligible for waitlist clearance. Among all the reservation records waitlisted on flights operated by the carrier in question, bookings that could potentially be confirmed may be identified by querying the booking database 20. This query may, for example, request the booking database 20 return all waitlisted reservation records that are associated with an origin-destination which matches one of the markets in the list of impacted markets.

In response to identifying the waitlisted reservation records, the inventory system 16 may group the identified reservation records 70 into sets of reservation records that may be competing for spaces on the same flights or segments. Under the above exemplary scenario, because reservation records VVVVVV and WWWWWW are both waitlisted on segment CA2, they may be competing for spaces on that segment. Thus, the inventory system 16 may group reservation records VVVVVV and WWWWWW together. Moreover, because reservation record ZZZZZZ and reservation record WWWWWW are both waitlisted on segment CA3, they may be competing for spaces on that segment. Accordingly, the inventory system 16 may group reservation record ZZZZZZ with reservation WWWWWW by adding reservation record ZZZZZZ to the set that includes reservation record VVVVVV and WWWWWW. Thus, in the above example, the three reservation records XXXXXX, YYYYYY, ZZZZZZ may be grouped together in the same set.

Once the reservation records have been identified 68 and grouped 70, the inventory system 16 may transmit a trigger message 72 to the reservation system 12. The trigger message 72 may contain the list of eligible reservation records identified 68 and grouped 70 by the inventory system 16. In cases where there are multiple sets of reservation records, each set may be transmitted to the reservation system 12 in a separate trigger message (not shown) to be processed separately by the reservation system 12. Grouping reservation records competing for spaces in the same flight together in a single trigger message may facilitate comparing the priority of the reservation records before starting the confirmation process.

For each reservation record listed in the trigger message 72, the reservation system 12 may gather data 74 related to the reservation record (e.g., the segments comprising the travel solution and the number of passengers on each segment), and generate an availability request 76. The reservation system 12 may gather data by, for example, retrieving the identified reservation record from the reservation database 18. The availability request 76 may be configured to request sufficient availability for each waitlisted segment or booking class in the reservation record to confirm each passenger waitlisted on the segment. The reservation system 12 may also enrich the availability request message with contextual information (e.g., contextual segments, frequent flyer information, etc.) obtained from the reservation record. The reservation system 12 may then transmit the availability request 78 to the inventory system 16.

An exemplary availability request in accordance with the exemplary scenario described above with respect to Carrier A may appear as follows:

UNH+1+IAWCRQ:09:1:1A′

ODI+HAM+JFK′

TVL+010414:0800:010414:0915+HAM+FRA+CA+1:C+1+1+P′

TVL+010414:1100:010414:1500+FRA+JFK+CA+2:C+1+2+P′

ORG+1A:NCE+:NCE1A0955+++A+FR′

ODI+FRA+MIA′

TVL+010414:1100:010414:1500+FRA+JFK+CA+2:C+2+1+P′

TVL+010414:1500:010414:1800+JFK+MIA+CA+3:C+2+2+P′

ORG+1A:MUC+:MUC1A0001+++A+DE′

ODI+MUC+MIA′

TVL+010414:0800:010414:1045+MUC+JFK+CA+4:C+3+1+P′

TVL+010414:1500:010414:1800+JFK+MIA+CA+3:C+3+2+P′

ORG+1A:NCE+:NCE1A0990+++A+FR′

UNT+14+1′

Rows, or “segments” 2-5 of the above availability request message may correspond to the travel solution and originator information of reservation record VVVVVV. Segments 6-9 may correspond to the travel solution and originator information of reservation record WWWWWW. Segments 10-13 may correspond to the travel solution and originator information of reservation record ZZZZZZ. By way of explanation, each travel segment may begin with the character string “TVL”. This text string may be followed by a departure time (e.g., “010414:0800”, or 8:00 AM, Jan. 4, 2014), an arrival time (e.g., “010414:0915”, or 9:15 AM, Jan. 4, 2014), a departure location (e.g., “HAM”, or Hamburg), an arrival location (e.g., “FRA”, or Frankfurt) a segment identifier (e.g., “CA+1”, or Carrier A, segment 1), and a class of service (e.g., “C+1+1”, or coach booking class and cabin class). Travel segments that are to be polled may terminate with a polling indicator (e.g., “P′”). The polling indicator may indicate that availability for corresponding segment is to be polled. If the reservation record is waitlisted on that segment or class, polling may be indicated because availability has to be reevaluated for that travel segment.

In response to receiving the availability request 78, the inventory system 16 may determine availability for each waitlisted segment and/or booking class in each eligible reservation record. Prior to calculating availability, the inventory system may perform one or more preliminary checks 80 to filter out travel solutions that cannot be confirmed. These preliminary checks may include checking flight date inventory data, gross added value, booking class inhibit waitlist clearance flags, and segment booking/cabin class continuity.

During the preliminary checks 80, the inventory system 16 may filter out travel solutions that cannot be confirmed according to the flight date inventory, and travel solutions for which the gross added value falls below a predetermined threshold. The inventory system 16 may also filter out any travel solution including a segment with a booking class for which an inhibit waitlist clearance flag is set. The inhibit waitlist clearance flag may indicate that the rules for the booking class in question do not allow wait-listing. In cases where the polled segment includes more than one leg, the inventory system 16 may check availability of requested booking/cabin classes in both legs since the booking cannot be confirmed on a segment having multiple legs unless a space satisfying the booking/cabin class is available for each leg of the segment.

If the travel solution passes the preliminary checks 80, the inventory system 16 may calculate availability for the travel solution 82, taking into account the contextual information in the availability request 78. The inventory system 16 may then transmit a reply 84 to the reservation system 12. The reply 84 may include dedicated error data identifying travel solutions that were filtered out, and the results of the availability calculation for each polled segment for the remaining travel solutions.

We now apply the above processing to the exemplary scenario, and assume that for booking class C on segment HAM-FRA waitlist clearance is inhibited, for booking class C on segment FRA-JFK waitlist clearance is not inhibited and there are available spaces in cabin C, for booking class C on segment JFK-MIA waitlist clearance is not inhibited and there are available spaces in cabin C, and for booking class C on segment MUC-JFK waitlist clearance is not inhibited and there are available spaces in cabin C. Under these conditions, travel solution CA1(HL)-CA2(HL) of reservation record XXXXXX may be filtered out due to the waitlist clearance inhibit flag being set for booking class C on segment HAM-FRA. However, the inventory system 16 may calculate availability for the remaining travel solutions CA2(HL)-CA3(HL) and CA4(HL)-CA3(HL) since they satisfy the preliminary filtering criteria. Under this scenario, the following exemplary availability reply may be sent to the reservation system 12:

UNH+1+IAWCRR:09:1:1A′

ODI+HAM+JFK′

TVL+010414:0800:010414:0915+HAM+FRA+CA+1+1+1′

ERC+XXX′

TVL+010414:1100:010414:1500+FRA+JFK+CA+2+1+2′

ERC+XXX′

ODI+FRA+MIA′

TVL+010414:1100:010414:1500+FRA+JFK+CA+2+2+1′

PDI++C:1′

MON+EFY:399:EUR′

TVL+010414:1500:010414:1800+JFK+MIA+CA+3+2+2′

PDI++C:1′

MON+EFY:399:EUR′

ODI+MUC+MIA′

TVL+010414:0800:010414:1045+MUC+JFK+CA+4+3+1′

PDI++C:1′

MON+EFY:50:EUR′

TVL+010414:1500:010414:1800+JFK+MIA+CA+3+3+2′

PDI++C:1′

MON+EFY:50:EUR′

UNT+21+1′

Segments 2-6 of the reply may correspond to PNR VVVVVV. Segments identified by an application error information (ERC) prefix may indicate an error for flight segments CA1 and CA2 was returned because waitlist clearance was inhibited on one of the segments. Segments 7-13 may correspond to reservation record WWWWWW, and segments 14-20 may correspond to reservation record ZZZZZZ. For each segment class polled in the request, availability may be returned in a segment identified by a personal demographic information (PDI) prefix. Effective yield may be returned in segments identified by a monetary information (MON) prefix. Information in the reply for waitlisted travel solutions with availability, such as the effective yield, may be used as a ranking criterion for the reservation record, as discussed in more detail below.

In response to receiving the reply 84, the reservation system 12 may rank the reservation records 86 according to a passenger customer value. To this end, the reservation system 12 may assess the priority of each reservation record based on characteristics of the reservation and the passenger. The passenger customer value may be determined based on a profile of the passenger, such as frequent flyer club membership, tier, and account information. The reservation record may also be ranked based on, for example, booking class, fare paid, and market served.

Returning to the exemplary scenario, reservation record WWWWWW may be assigned a higher priority than reservation record ZZZZZZ because the passenger in reservation record WWWWWW is a frequent flyer, and/or the reservation record has a higher effective yield. Under this scenario, reservation record WWWWWW may be ranked one among the two eligible reservation records, and reservation record ZZZZZZ may be ranked two. That is, reservation record WWWWWW may be the highest ranked reservation record in the set, and reservation record ZZZZZZ may be the next highest ranked reservation record in the set. In addition, because ZZZZZZ is ranked second out of the two reservation records in the set, it may also be considered the lowest ranked reservation record in the set.

Once the reservation records have been ranked 86, the reservation system 12 may transmit a confirmation request 88 to the inventory system 16. The confirmation request 88 may indicate that segments for which confirmation was requested in reply 84 were polled. The confirmation request 88 may also include contextual information and the rank of each reservation record as determined by the reservation system 12.

For the exemplary scenario, the confirmation request may appear as follows:

UNH+1+IWCCUQ:09:1:1A′

ORG+00+:NCE1A0955+++++A0001AARC′

RCI+:YYYYYY′

PTY+RNK+:::1′

ORG+1A:MUC+:MUC1A0001+++A+DE′

ODI+FRA+MIA′

ITM+1′

TVL+010414:1100:010414:1500+FRA+JFK+RA+2:C+++P′

RPI+1′

STX+CFW′

IRV++++::DID:231044A700005421+::IID:07000002A494B8CD′

ITM+1′

TVL+010414:1500:010414:1800+JFK+MIA+RA+3:C+++P′

RPI+1′

STX+CFW′

IRV++++::DID:231044A700005422+::IID:07000002A494B8CE′

RCI+:ZZZZZZ′

PTY+RNK+:::2′

ORG+1A:NCE+:NCE1A0990+++A+FR′

ODI+MUC+MIA′

ITM+1′

TVL+010414:0800:010414:1045+MUC+JFK+RA+4:C+++P′

RPI+1′

STX+CFW′

IRV++++::DID:231044A700005421+::IID:07000002A494B8CD′

ITM+1′

TVL+010414:1500:010414:1800+JFK+MIA+RA+3:C+++P′

RPI+1′

STX+CFW′

IRV++++::DID:231044A700005422+::IID:07000002A494B8CE′

UNT+32+1′

Segments 2-15 of the above confirmation request may correspond to reservation record WWWWWW, as indicated by the segment with a reservation control information (RCI) prefix. As can be seen, the segment having the PTY prefix indicates the rank of reservation record WWWWWW as “1”. Similarly, segments 16-29 of the above confirmation request may correspond to reservation record ZZZZZZ, as indicated by segment 16, which also has the RCI prefix. As can be seen from line 17, the rank of reservation record ZZZZZZ is “2”.

In response to receiving the confirmation request 88, the inventory system 16 may attempt to confirm the reservation records 90. The attempts to confirm the polled segments in the reservation records may be confirmed in the order indicated by the ranking information in the confirmation request 88.

In the exemplary scenario, the inventory system 16 may try to confirm reservation record WWWWWW based on its rank. Reservation record WWWWWW may be confirmed because the origin-destination availability is sufficient, as indicated by PDI segments of the exemplary availability reply above, which indicates one available coach class space in each of the FRA-JFK and JFK-MIA segments. After confirming the waitlisted travel solution in reservation record WWWWWW, the inventory system 16 may try to confirm the next highest ranked reservation record ZZZZZZ. Although the origin-destination availability is indicated as sufficient by the corresponding PDI segments of the exemplary availability reply above, reservation record ZZZZZZ may be rejected because confirming reservation record WWWWWW may have taken the last available coach class space on segment JKF-MIA.

In response to completing the attempts to confirm the eligible reservation records 90, the inventory system may transmit a confirmation response 92 to the reservation system 12. For the exemplary scenario, the confirmation response 92 may appear as follows:

UNH+1+IWCCUR:09:1:1A′

RCI+:YYYYYY′

ODI+FRA+MIA′

ITM+1′

TVL+010414:1100:010414:1500+FRA+JFK+RA+2:C′

STX+CFW′

REF+CNX:1+SEQ:1+FFF:1′

REF+MAR:1+SEQ:1+FFF:1′

IRV++++::DID:231044A700005421+::IID:07000002A494B8CD′

ITM+1′

TVL+010414:1500:010414:1800+JFK+MIA+RA+3:C′

STX+CFW′

REF+CNX:1+SEQ:2+FFF:2′

REF+MAR:1+SEQ:2+FFF:2′

IRV++++::DID:231044A700005422+::IID:07000002A494B8CE′

RCI+:ZZZZZZ′

ODI+MUC+MIA′

ITM+1′

TVL+010414:0800:010414:1045+MUC+JFK+RA+4:C′

STX+NOA′

REF+CNX:1+SEQ:1+FFF:1′

REF+MAR:1+SEQ:1+FFF:1′

IRV++++::DID:231044A700005421+::IID:07000002A494B8CD′

ITM+1′

TVL+010414:1500:010414:1800+JFK+MIA+RA+3:C′

STX+NOA′

REF+CNX:1+SEQ:2+FFF:2′

REF+MAR:1+SEQ:2+FFF:2′

IRV++++::DID:231044A700005422+::IID:07000002A494B8CE′

UNT+30+1′

Segments 2-15 of the exemplary confirmation response 92 may correspond to reservation record WWWWWW, as indicated by segment two with the RCI prefix. The sixth segment includes an STX prefix, and indicates that the travel solution was confirmed from waitlist (CFW). Segments 16-29 of the exemplary confirmation response 92 may correspond to reservation record ZZZZZZ, as indicated by segment 16 with the RCI prefix. For reservation record ZZZZZZ, segment 20 having the STX prefix indicates that no action (NOA) was taken for the travel solution. That is, the travel solution was not confirmed.

Detecting events that have the potential to enable confirmation of waitlisted reservation records, and triggering waitlist clearance based thereon may improve the speed and frequency with which waitlisted travel solutions are confirmed. Events that may be detected may include changes to control parameters, such as yield, active valuation strategies, and business rules. Waitlist clearance triggers may thereby be generated at an origin-destination level rather than at a segment level. Triggering waitlist clearance at the origin-destination level rather than at the segment level may provide an increased number of eligible reservation records for waitlist clearance as compared to reservation systems lacking this feature. These improvements in trigger speed, identification of eligible reservation records, and batch processing of eligible reservation records may also result in improved enforcement of reservation record ranking.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system comprising:
one or more processors; and
a memory in communication with the one or more processors, the memory storing:
a first database of control parameters each associated with one or more origin-destination pairs,
a second database of reservation records each defining a travel solution, and
a third database of index records each associating a respective reservation record in the second database with an origin-destination pair that corresponds to the travel solution defined by the respective reservation record, and
program code that, when executed by at least one of the one or more processors, causes the system to:
in response to detecting an update to the first database, identify one of the control parameters in the first database that was modified by the update;
retrieve, from the third database, each index record for which the origin-destination pair matches one of the one or more origin-destination pairs associated with the identified control parameter;
retrieve, from the second database, each reservation record corresponding to at least one of the index records retrieved from the third database;
select a reservation record from the reservation records retrieved from the second database;
determine an availability of spaces for the travel solution defined by the selected reservation record using the identified control parameter from the first database; and
if the availability of spaces is sufficient to accommodate the travel solution, confirm the travel solution.

2. The system of claim 1 wherein each respective reservation record associated with a corresponding origin-destination pair by the third database of index records has a status of waitlisted, and the program code further causes the system to:
in response to confirming the travel solution, update the status of the respective reservation record from waitlisted to confirmed.

3. The system of claim 1 wherein the program code causes the system to determine the availability of spaces for the travel solution by:
transmitting, to an inventory system, a query identifying the respective reservation record and a number of passengers to be accommodated; and
in response to the query, receiving a reply from the inventory system indicating whether the availability of spaces determined by the inventory system is sufficient.

4. The system of claim 1 wherein the reservation records retrieved from the second database comprise a first set of reservation records, and the program code causes the system to select the selected reservation record by:
for each reservation record in the first set of reservation records:
determining the availability of spaces for the travel solution defined by the reservation record using the identified control parameter from the first database, and
if the availability of spaces is sufficient to accommodate the travel solution, adding the reservation record to a second set of reservation records;
ranking each reservation record in the second set of reservation records; and
identifying a highest ranked reservation record in the second set of reservation records as the selected reservation record.

5. The system of claim 4 wherein the program code causes the system to rank each reservation record in the second set of reservation records by:
determining a value for each reservation record in the second set of reservation records based on a characteristic of a passenger associated with the travel solution or an effective yield of the travel solution; and
arranging each reservation record in the second set of reservation records based on the value.

6. The system of claim 5 wherein the program code further causes the system, until the availability of spaces is no longer sufficient to accommodate another reservation record having the status of waitlisted, or each reservation record in the second set of reservation records has been processed, to iteratively:
determine the availability of spaces for the travel solution of a next highest ranked reservation record in the second set of reservation records; and
if the availability of spaces is sufficient to accommodate the travel solution, confirm the travel solution.

7. The system of claim 1 wherein the identified control parameter is one of a plurality of control parameters in the first database that were modified by the update, and the system retrieves each index record for which the origin-destination pair matches any one of the origin-destination pairs associated with any one of the plurality of control parameters that were modified.

8. The system of claim 1 wherein the program code causes the system to detect the update to the first database by:
determining a first state of the first database of control parameters before the update;
determining a second state of the first database of control parameters after the update;
comparing the first state and the second state; and
in response to the second state differing from the first state, indicating an occurrence of the update.

9. The system of claim 8 wherein the update to the first database comprises a change of an active valuation strategy, a business rule, a yield, or a bid price.

10. A method of monitoring a first database of control parameters each associated with one or more origin-destination pairs to trigger a waitlist clearance process in a second database of reservation records each defining a travel solution, the method comprising:
in response to detecting an update to the first database, identifying one of the control parameters in the first database that was modified by the update;
retrieving, from a third database of index records each associating a respective reservation record in the second database with an origin-destination pair that corresponds to the travel solution defined by the respective reservation record, each index record for which the origin-destination pair matches one of the one or more origin-destination pairs associated with the identified control parameter;
retrieving, from the second database, each reservation record corresponding to at least one of the index records retrieved from the third database;
selecting a reservation record from the reservation records retrieved from the second database;
determining an availability of spaces for the travel solution defined by the selected reservation record using the identified control parameter from the first database; and
if the availability of spaces is sufficient to accommodate the travel solution, confirming the travel solution.

11. The method of claim 10 wherein each respective reservation record associated with a corresponding origin-destination pair by the third database of index records has a status of waitlisted, and further comprising:
in response to confirming the travel solution, updating the status of the respective reservation record from waitlisted to confirmed.

12. The method of claim 10 wherein determining the availability of spaces for the travel solution comprises:
transmitting, to an inventory system, a query identifying the respective reservation record and a number of passengers to be accommodated; and
in response to the query, receiving a reply from the inventory system indicating whether the availability of spaces determined by the inventory system is sufficient.

13. The method of claim 10 wherein the reservation records retrieved from the second database comprise a first set of reservation records, and selecting the reservation record comprises:
for each reservation record in the first set of reservation records:
determining the availability of spaces for the travel solution defined by the reservation record using the identified control parameter from the first database, and
if the availability of spaces is sufficient to accommodate the travel solution, adding the reservation record to a second set of reservation records;
ranking each reservation record in the second set of reservation records; and
identifying a highest ranked reservation record in the second set of reservation records as the selected reservation record.

14. The method of claim 13 further comprising:
filtering the second set of reservation records to remove each reservation record for which a waitlist clearance is inhibited.

15. The method of claim 13 wherein ranking each reservation record in the second set of reservation records comprises:
determining a value for each reservation record in the second set of reservation records based on a characteristic of a passenger associated with the travel solution or an effective yield of the travel solution; and
arranging each reservation record in the second set of reservation records based on the value.

16. The method of claim 13 further comprising, until the availability of spaces is no longer sufficient to accommodate another reservation record having the status of waitlisted, or each reservation record in the second set of reservation records has been processed, iteratively:
determining the availability of spaces for the travel solution of a next highest ranked reservation record in the second set of reservation records; and
if the availability of spaces is sufficient to accommodate the travel solution, confirming the travel solution.

17. The method of claim 10 wherein the identified control parameter is one of a plurality of control parameters in the first database that were modified by the update, and further comprising:
retrieving each index record for which the origin-destination pair matches any one of the origin-destination pairs associated with any one of the plurality of control parameters that were modified.

18. The method of claim 10 wherein detecting the update to the first database comprises:
determining a first state of the first database of control parameters before the update;
determining a second state of the first database of control parameters after the update;
comparing the first state and the second state; and
in response to the second state differing from the first state, indicating an occurrence of the update.

19. The method of claim 18 wherein the update to the first database comprises a change of an active valuation strategy, a business rule, a yield, or a bid price.

20. A computer program product for monitoring a first database of control parameters each associated with one or more origin-destination pairs to trigger a waitlist clearance process in a second database of reservation records each defining a travel solution, the computer program product comprising:
a non-transitory computer-readable storage medium; and
program code stored on the non-transitory computer-readable storage medium that, when executed by one or more processors, causes the one or more processors to:
in response to detecting an update to the first database, identify one of the control parameters in the first database that was modified by the update;
retrieve, from a third database of index records each associating a respective reservation record in the second database with an origin-destination pair that corresponds to the travel solution defined by the respective reservation record, each index record for which the origin-destination pair matches one of the one or more origin-destination pairs associated with the identified control parameter;
retrieve, from the second database, each reservation record corresponding to at least one of the index records retrieved from the third database;
select a reservation record from the reservation records retrieved from the second database;
determine an availability of spaces for the travel solution defined by the selected reservation record using the identified control parameter from the first database; and
if the availability of spaces is sufficient to accommodate the travel solution, confirm the travel solution.
